(19) United States
(12) Patent Application Publication
(10) Pub. No.: US 2012/0014211 A1
(43) Pub. Date: Jan. 19, 2012

(54) MONITORING OF OBJECTS IN CONJUNCTION WITH A SUBTERRANEAN WELL

(75) Inventors: John L. MAIDA, JR., Houston, TX (US); Norman WARPINSKI, Cypress, TX (US); Etienne M. SAMSON, Houston, TX (US); Lawrence G. GRIFFIN, Tulsa, OK (US)

(73) Assignee: HALLIBURTON ENERGY SERVICES, INC., Houston, TX (US)

(21) Appl. No.: 12/838,726

(22) Filed: Jul. 19, 2010

(51) Int. Cl. H04B 17/00

(52) U.S. Cl. 367/13

(57) ABSTRACT

Objects are monitored in a subterranean well. A well system can include at least one object having a transmitter, and at least one sensing device which monitors displacement of the object along a wellbore. A method of monitoring at least one object in a subterranean well can include positioning at least one sensing device in a wellbore of the well, and then displacing the object through the wellbore, the sensing device monitoring the object as it displaces through the wellbore.

### BACKGROUND

This disclosure relates generally to equipment utilized and operations performed in conjunction with a subterranean well and, in an example described below, more particularly provides for monitoring of objects in a subterranean well.

Various objects (such as well tools, ball sealers, other plugging devices, etc.) are commonly used in wells. However, it is generally not possible to monitor certain characteristics, configurations of such objects in wells.

Other objects (such as tiltmeters, etc.) are used outside of a wellbore, but it is still desirable to monitor such objects from a remote location. If the objects are in a relatively inaccessible location (such as a sea floor), convenience, reliability and efficiency of installation can be very beneficial.

It will, thus, be readily appreciated that improvements are needed in the art of monitoring objects in conjunction with a subterranean well.

### SUMMARY

In the disclosure below, systems and methods are provided which bring improvements to the art of monitoring objects. One example is described below in which displacement of an object along a wellbore can be effectively monitored using a sensing device. Another example is described below in which a sensing device and an object can communicate without a direct connection between them.

In one aspect, a well system is provided to the art by the present disclosure. The well system can include at least one object having a transmitter. At least one sensing device monitors displacement of the object along a wellbore.

In another aspect, a method of monitoring at least one object in a subterranean well is provided. The method can include positioning at least one sensing device in a wellbore of the well, and then displacing the object through the wellbore, the sensing device monitoring the object as it displaces through the wellbore.

These and other features, advantages and benefits will become apparent to one of ordinary skill in the art upon careful consideration of the detailed description of representative examples below and the accompanying drawings, in which similar elements are indicated in the various figures using the same reference numbers.

### BRIEF DESCRIPTION OF THE DRAWINGS

FIG. 1 is a schematic cross-sectional view of a well system and associated method embodying principles of the present disclosure.

FIG. 2 is an enlarged scale schematic cross-sectional view of an object which may be used in the well system of FIG. 1.

FIG. 3 is a schematic cross-sectional view of another configuration of the well system.

FIG. 4 is a schematic cross-sectional view of yet another configuration of the well system.

FIG. 5 is a schematic cross-sectional view of a further configuration of the well system.

FIG. 6 is an enlarged scale schematic cross-sectional view of a cable which may be used in the well system.

FIG. 7 is a schematic cross-sectional view of the cable of FIG. 6 attached to an object which transmits a signal to the cable.

FIG. 8 is a schematic plan view of a sensing system which embodies principles of this disclosure.

### DETAILED DESCRIPTION

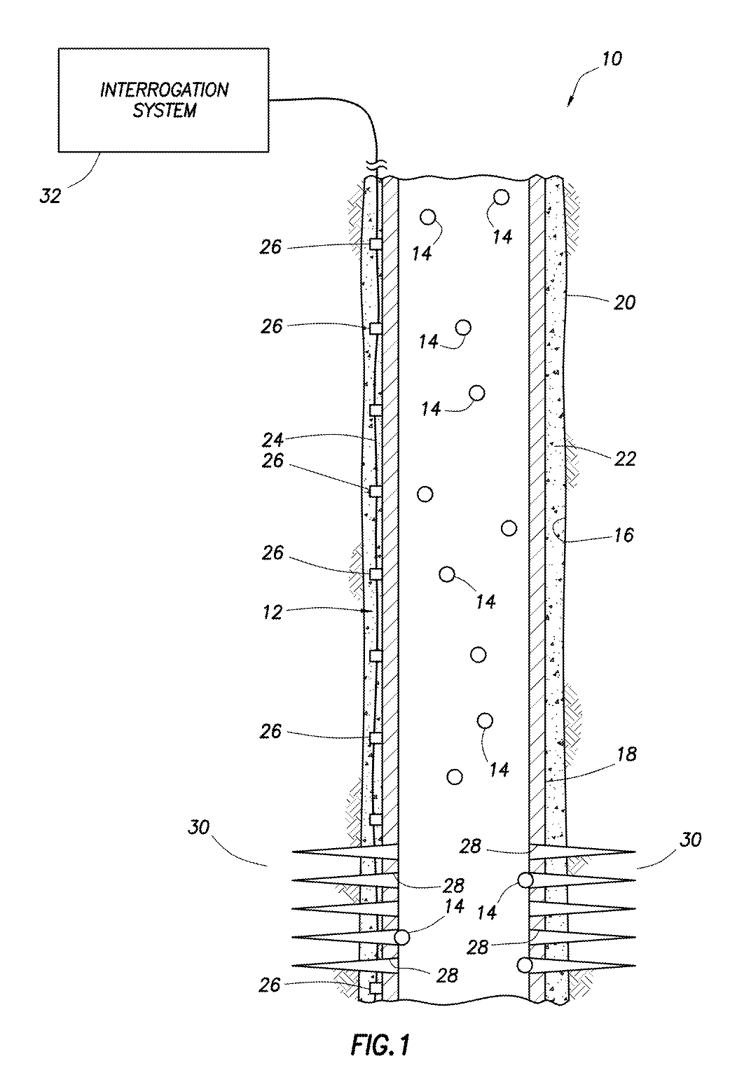

Representatively illustrated in FIG. 1 is a well system 10 and associated method which embody principles of this disclosure. In the system 10 as depicted in FIG. 1, a sensing system 12 is used to monitor objects 14 displaced through a wellbore 16. The wellbore 16 in this example is lined with casing 18 and cement 20.

As used herein, the term “cement” is used to indicate a hardenable material which is used to seal off an annular space in a well, such as an annulus 22 formed radially between the wellbore 16 and casing 18. Cement is not necessarily cementitious, since other types of materials (e.g., polymers, such as epoxies, etc.) can be used in place of, or in addition to, a Portland type of cement. Cement can harden by hydrating, by passage of time, by application of heat, by cross-linking, and/or by any other technique.

As used herein, the term “casing” is used to indicate a generally tubular string which forms a protective wellbore lining. Casing may include any of the types of materials known to those skilled in the art as casing, liner or tubing. Casing may be segmented or continuous, and may be supplied ready for installation, or may be formed in situ.

The sensing system 12 comprises at least one sensing device 24, depicted in FIG. 1 as a line extending along the wellbore 16. In the example of FIG. 1, the sensing device 24 is positioned external to the casing 18, in the annulus 22 and in contact with the cement 20.

In other examples, the sensing device 24 could be positioned in a wall of the casing 18, in the interior of the casing, in another tubular string in the casing, in an uncased section of the wellbore 16, etc. Thus, it should be understood that the principles of this disclosure are not limited to the placement of the sensing device 24 as depicted in FIG. 1.

The sensing system 12 may also include sensors 26 longitudinally spaced apart along the casing 18. However, preferably the sensing device 24 itself serves as a sensor, as described more fully below. Thus, the sensing device 24 may be used as a sensor, whether or not the other sensors 26 are also used.

Although only one sensing device 24 is depicted in FIG. 1, any number of sensing devices may be used. An example of three sensing devices 24a-c in a cable 60 of the sensing system 12 is depicted in FIGS. 6 & 7.

The objects 14 in the example of FIG. 1 are preferably of the type known to those skilled in the art as ball sealers, which are used to seal off perforations 28 for diversion purposes in fracturing and other types of stimulation operations. The perforations 28 provide fluid communication between the interior of the casing 18 and an earth formation 30 intersected by the wellbore 16.

It would be beneficial to be able to track the displacement of the objects 14 as they fall or are flowed with fluid through the casing 18. It would also be beneficial to know the position of each object 14, to determine which of the objects have located in appropriate perforations 28 (and thereby know which perforations remain open), to receive sensor measurements (such as pressure, temperature, pH, etc.) from the objects, etc.

Using the sensing device 24 as a sensor, transmissions from the objects 14 can be detected and the position, velocity, identity, etc. of the objects along the wellbore 16 can be known. Indications of parameters sensed by sensor(s) in the objects 14 can also be detected.

In one embodiment, the sensing device 24 can comprise one or more optical waveguides, and information can be transmitted acoustically from the objects 14 to the optical waveguides. For example, an acoustic signal transmitted from an object 14 to the sensing device 24 can cause vibration of an optical waveguide, the location and other characteristics of which can be detected by use of an interrogation system 32. The interrogation system 32 may detect Brillouin backscatter gain or coherent Rayleigh backscatter which results from light being transmitted through the optical waveguide.

The optical waveguide(s) may comprise optical fibers, optical ribbons or any other type of optical waveguides. The optical waveguide(s) may comprise single mode or multi-mode waveguides, or any combination thereof.

The interrogation system 32 is optically connected to the optical waveguide at a remote location, such as the earth's surface, a sea floor or subsea facility, etc. The interrogation system 32 is used to launch pulses of light into the optical waveguide, and to detect optical reflections and backscatter indicative of parameters sensed by the sensing device 24, the sensors 26 and/or sensors of the objects 14. The interrogation system 32 can comprise one or more lasers, interferometers, photodetectors, optical time domain reflectometers (OTDR's) and/or other conventional optical equipment well known to those skilled in the art.

The sensing system 12 preferably uses a combination of two or more distributed optical sensing techniques. These techniques can include detection of Brillouin backscatter and/or coherent Rayleigh backscatter resulting from transmission of light through the optical waveguide(s). Raman backscatter may also be detected and, if used in conjunction with detection of Brillouin backscatter, may be used for thermally calibrating the Brillouin backscatter detection data in situations where accurate strain measurements are desired.

Optical sensing techniques can be used to detect static strain, dynamic strain, acoustic vibration and/or temperature. These optical sensing techniques may be combined with any other optical sensing techniques, such as hydrogen sensing, stress sensing, etc.

Brillouin backscatter detection is preferably used to monitor static strain, with data collected at time intervals of a few seconds to hours. Most preferably, coherent Rayleigh backscatter is detected as an indication of vibration of an optical waveguide.

The optical waveguides could include one or more waveguides for Brillouin backscatter detection, depending on the Brillouin method used (e.g., linear spontaneous or non-linear stimulated). The Brillouin backscattering detection technique measures the natural acoustic velocity via corresponding scattered photon frequency shift in a waveguide at a given location along the waveguide.

The frequency shift is induced by changes in density of the waveguide. The density, and thus acoustic velocity, can be affected primarily by two parameters: strain and temperature.

In long term monitoring, it is expected that the temperature will remain fairly stable. If the temperature is stable, any changes monitored with a Brillouin backscattering detection technique would most likely be due to changes in strain.

Preferably, however, accuracy will be improved by independently measuring strain and/or temperature, in order to calibrate the Brillouin backscatter measurements. An optical waveguide which is mechanically decoupled from the cement 20 and any other sources of strain may be used as an effective source of temperature calibration for the Brillouin backscatter strain measurements.

Coherent Rayleigh backscatter is preferably used to monitor dynamic strain (e.g., acoustic pressure and vibration). Coherent Rayleigh backscatter detection techniques can detect acoustic signals which result in vibration of the optical waveguide.

Raman backscatter detection techniques are preferably used for monitoring distributed temperature. Such techniques are known to those skilled in the art as distributed temperature sensing (DTS).

Raman backscatter is relatively insensitive to distributed strain, although localized bending in a waveguide can be detected. Temperature measurements obtained using Raman backscatter detection techniques can, therefore, be used for temperature calibration of Brillouin backscatter measurements.

Raman light scattering is caused by thermally influenced molecular vibrations. Consequently, the backscattered light carries the local temperature information at the point where the scattering occurred.

The amplitude of an Anti-Stokes component is strongly temperature dependent, whereas the amplitude of a Stokes component of the backscattered light is not. Raman backscatter sensing requires some optical-domain filtering to isolate the relevant optical frequency (or optical wavelength) components, and is based on the recording and computation of the ratio between Anti-Stokes and Stokes amplitude, which contains the temperature information.

Since the magnitude of the spontaneous Raman backscattered light is quite low (e.g., 10 dB less than Brillouin backscattering), high numerical aperture (high NA) multi-mode optical waveguides are typically used, in order to maximize the guided intensity of the backscattered light. However, the relatively high attenuation characteristics of highly doped, high NA, graded index multi-mode waveguides, in particular, limit the range of Raman-based systems to approximately 10 km.

Brillouin light scattering occurs as a result of interaction between the propagating optical signal and thermally excited acoustic waves (e.g., within the GHz range) present in silica optical material. This gives rise to frequency shifted components in the optical domain, and can be seen as the diffraction of light on a dynamic in situ “virtual” optical grating generated by an acoustic wave within the optical media. Note that an acoustic wave is actually a pressure wave which introduces a modulation of the index of refraction via the elasto-optic effect.

The diffracted light experiences a Doppler shift, since the grating propagates at the acoustic velocity in the optical media. The acoustic velocity is directly related to the silica media density, which is temperature and strain dependent. As a result, the so-called Brillouin frequency shift carries with it information about the local temperature and strain of the optical media.

Note that Raman and Brillouin scattering effects are associated with different dynamic non-homogeneities in silica optical media and, therefore, have completely different spectral characteristics.

Coherent Rayleigh light scattering is also caused by fluctuations or non-homogeneities in silica optical media density, but this form of scattering is purely “elastic.” In contrast, both Raman and Brillouin scattering effects are “inelastic,” in that “new” light or photons are generated from the propagation of the laser probe light through the media.

In the case of coherent Rayleigh light scattering, temperature or strain changes are identical to an optical source (e.g., very coherent laser) wavelength change. Unlike conventional Rayleigh backscatter detection techniques (using common optical time domain reflectometers), because of the extremely narrow spectral width of the laser source (with associated long coherence length and time), coherent Rayleigh (or phase Rayleigh) backscatter signals experience optical phase sensitivity resulting from coherent addition of amplitudes of the light backscattered from different parts of the optical media which arrive simultaneously at a photodetector.

In another embodiment, the sensing device 24 can comprise an electrical conductor, and information can be transmitted acoustically or electromagnetically from the objects 14 to the sensing device. For example, an acoustic signal can cause vibration of the sensing device 24, resulting in triboelectric noise or piezoelectric energy being generated in the sensing device. An electromagnetic signal can cause a current to be generated in the sensing device 24, in which case the sensing device serves as an antenna.

Triboelectric noise results from materials being rubbed together, which produces an electrical charge. Triboelectric noise can be generated by vibrating an electrical cable, which results in friction between the cable's various conductors, insulation, fillers, etc. The friction generates a surface electrical charge.

Piezoelectric energy can be generated in a coaxial electric cable with material such as polyvinylidene fluoride (PVDF) being used as a dielectric between an inner conductor and an outer conductive braid. As the dielectric material is flexed, vibrated, etc., piezoelectric energy is generated and can be sensed as small currents in the conductors.

If the sensing device 24 comprises an electrical conductor (in addition to, or instead of, an optical waveguide), then the interrogation system 32 may include suitable equipment to receive and process signals transmitted via the conductor. For example, the interrogation system 32 could include digital-to-analog converters, digital signal processing equipment, etc.

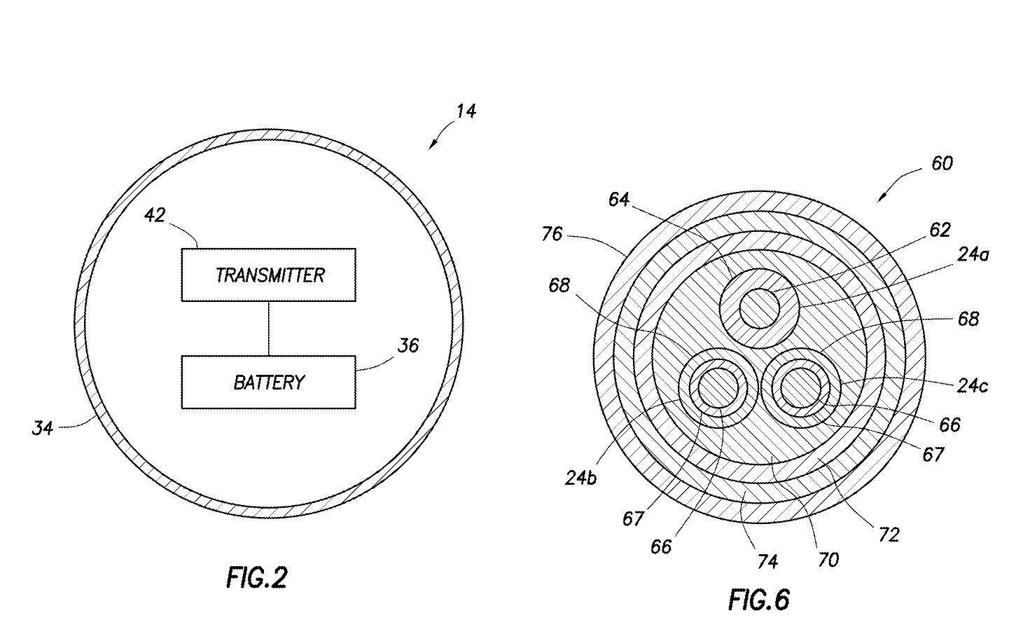

Referring additionally now to FIG. 2, an enlarged scale schematic cross-sectional view of one of the objects 14 is representatively illustrated. In this view, it may be seen that the object 14 includes a generally spherical hollow body 34 having a battery 36 and a transmitter 42 therein.

The battery 36 provides a source of electrical power for operating the other components of the object 14. The battery 36 is not necessary if, for example, a generator, electrical line, etc. is used to supply electrical power, electrical power is not needed to operate other components of the object 14, etc.

The transmitter 42 transmits an appropriate signal to the sensing device 24 and/or sensors 26. If an acoustic signal is to be sent, then the transmitter 42 will preferably emit acoustic vibrations. For example, the transmitter 42 could comprise a piezoelectric driver or voice coil for converting electrical signals into acoustic signals.

If an electromagnetic signal is to be sent, then the transmitter 42 will preferably emit electromagnetic waves. For example, the transmitter 42 could comprise a transmitting antenna.

If a thermal signal is to be sent, then the transmitter 42 could comprise a heater or other device which maintains a temperature difference relative to the surrounding wellbore environment.

If only the position and/or identity of the object 14 is to be determined, then the transmitter 42 could emit a continuous signal, which is tracked by the sensing system 12. A unique frequency or pulse rate of the signal could be used to identify a particular one of the objects 14.

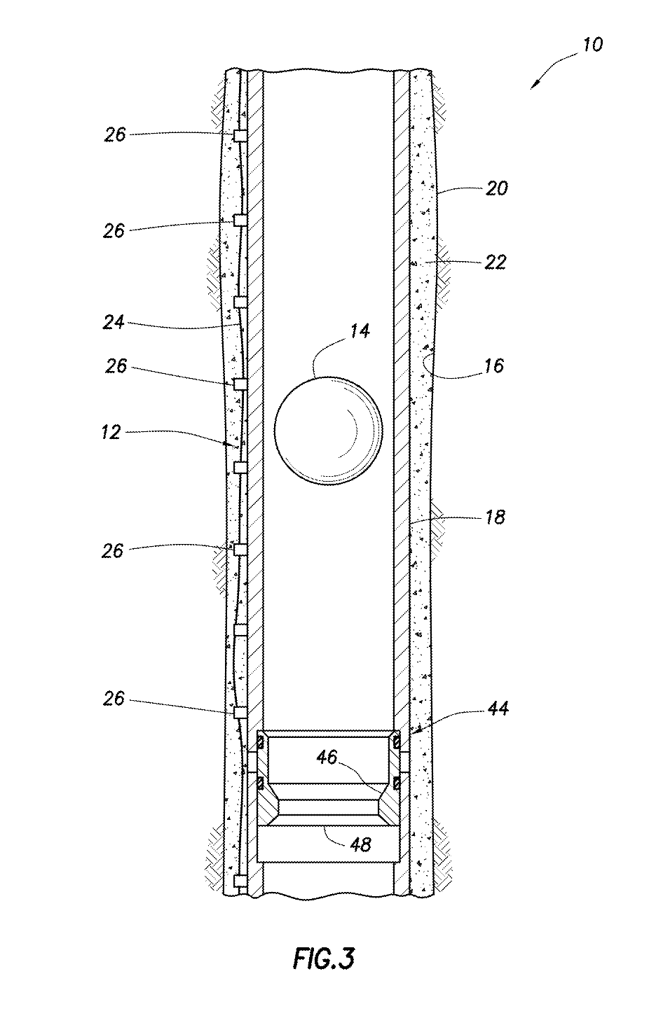

Referring additionally now to FIG. 3, another configuration of the well system 10 is representatively illustrated, in which the object 14 comprises a plugging device for operating a sliding sleeve valve 44. The configuration of FIG. 3 demonstrates that there are a variety of different well systems in which the features of the sensing system 12 can be beneficially utilized.

Using the sensing system 12, the position of the object 14 can be monitored as it displaces through the wellbore 16 to the valve 44. It can also be determined when or if the object 14 properly engages a seat 46 formed on a sleeve 48 of the valve 44.

It will be appreciated by those skilled in the art that many times different sized balls, darts or other plugging devices are used to operate particular ones of multiple valves or other well tools. The sensing system 12 enables an operator to determine whether or not a particular plugging device has appropriately engaged a particular well tool.

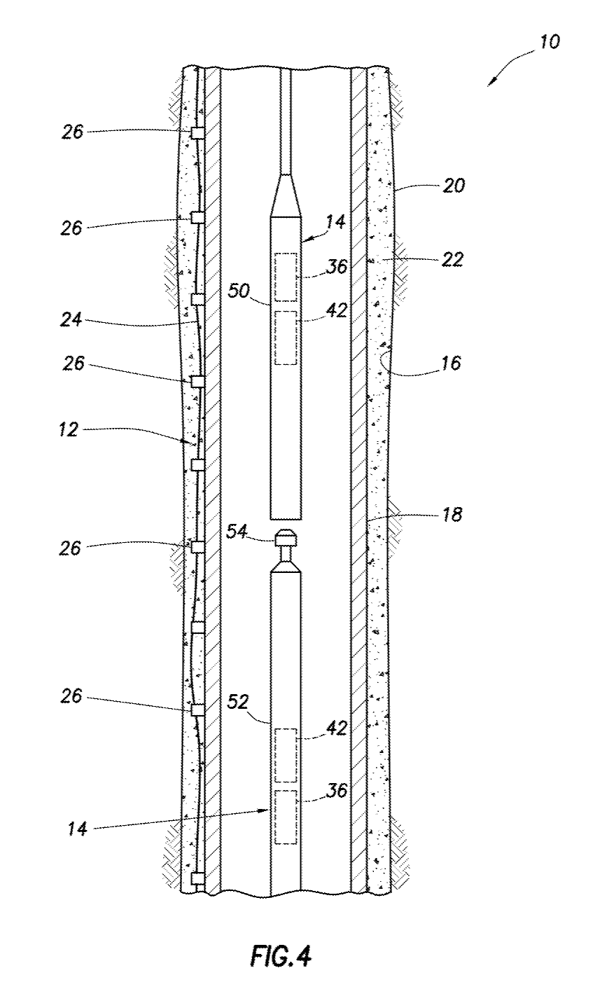

Referring additionally now to FIG. 4, another configuration of the well system 10 is representatively illustrated. In this configuration, the object 14 can comprise a well tool 50 (such as a wireline, slickline or coiled tubing conveyed fishing tool), or another type of well tool 52 (such as a “fish” to be retrieved by the fishing tool).

The positions of the well tools 50, 52 can be sensed by the sensing device 24, so that the progress of the operation can be monitored in real time from the surface or another remote location. Transmitters 42 in the well tools 50, 52 transmit signals (such as acoustic, electromagnetic, thermal signals, etc.) which are sensed by the sensing system 24.

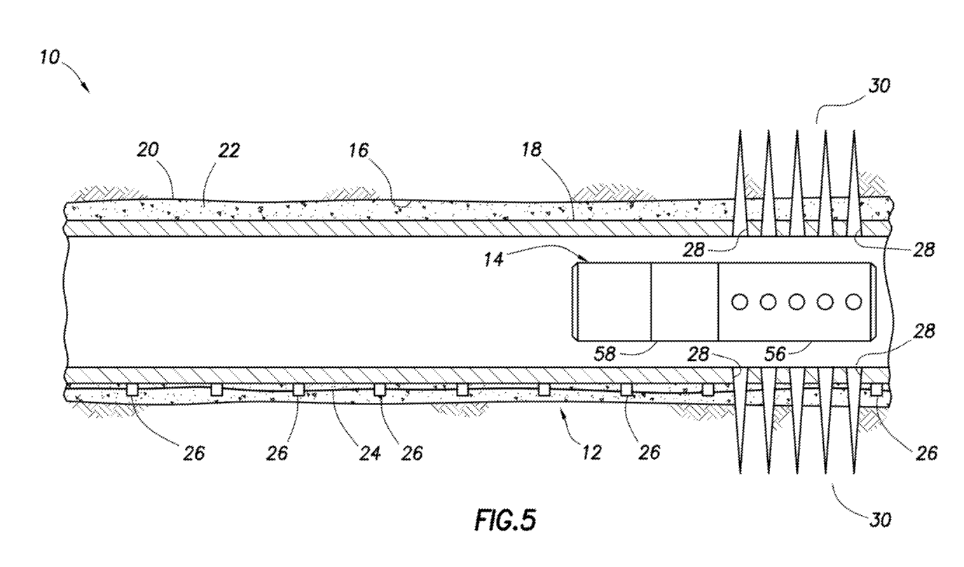

Referring additionally now to FIG. 5, another configuration of the well system 10 is representatively illustrated. In this configuration, the object 14 comprises a perforating gun 56 and firing head 58 which are displaced through a generally horizontal wellbore 16 (such as, by pushing the object with fluid pumped through the casing 18) to an appropriate location for forming perforations 28.

The displacement and location of the perforating gun 56 and firing head 58 can be conveniently monitored using the sensing system 12. It will be appreciated that, as the object 14 displaces through the casing 18, it will generate acoustic noise, which can be detected by the sensing system 12. Thus, in at least this way, the displacement and position of the object 14 can be readily determined using the sensing system 12.

Thus, it should be appreciated that the valve 44, well tools 50, 52, perforating gun 56 and firing head 58 are merely a few examples of a wide variety of well tools which can benefit from the principles of this disclosure.

Referring additionally now to FIG. 6, one configuration of a cable 60 which may be used in the sensing system 12 is representatively illustrated. The cable 60 may be used in place of, or in addition to, the sensing device 24 depicted in FIGS. 1 & 3-5. However, it should be clearly understood that the cable 60 may be used in other well systems and in other sensing systems, and many other types of cables may be used in the well systems and sensing systems described herein, without departing from the principles of this disclosure.

The cable 60 as depicted in FIG. 6 includes an electrical line 24a and two optical waveguides 24b,c. The electrical line 24a can include a central conductor 62 enclosed by insulation 64. Each optical waveguide 24b,c can include a core 66 enclosed by cladding 67, which is enclosed by a jacket 68.

In one embodiment, one of the optical waveguides 24b,c can be used for distributed temperature sensing (e.g., by detecting Raman backscattering resulting from light transmitted through the optical waveguide), and the other one of the optical waveguides can be used for distributed vibration or acoustic sensing (e.g., by detecting coherent Rayleigh backscattering or Brillouin backscatter gain resulting from light transmitted through the optical waveguide).

The electrical line 24a and optical waveguides 24b,c are merely examples of a wide variety of different types of lines which may be used in the cable 60. It should be clearly understood that any types of electrical or optical lines, or other types of lines, and any number or combination of lines may be used in the cable 60 in keeping with the principles of this disclosure.

Enclosing the electrical line 24a and optical waveguides 24b,c are a dielectric material 70, a conductive braid 72, a barrier layer 74 (such as an insulating layer, hydrogen and fluid barrier, etc.), and an outer armor braid 76. Of course, any other types, numbers, combinations, etc. of layers may be used in the cable 60 in keeping with the principles of this disclosure.

Note that each of the dielectric material 70, conductive braid 72, barrier layer 74 and outer armor braid 76 encloses the electrical line 24a and optical waveguides 24b,c and, thus, forms an enclosure surrounding the electrical line and optical waveguides. In certain examples, the electrical line 24a and optical waveguides 24b,c can receive signals transmitted from the transmitter 42 through the material of each of the enclosures.

For example, if the transmitter 42 transmits an acoustic signal, the acoustic signal can vibrate the optical waveguides 24b,c and this vibration of at least one of the waveguides can be detected by the interrogation system 32. As another example, vibration of the electrical line 24a resulting from the acoustic signal can cause triboelectric noise or piezoelectric energy to be generated, which can be detected by the interrogation system 32.

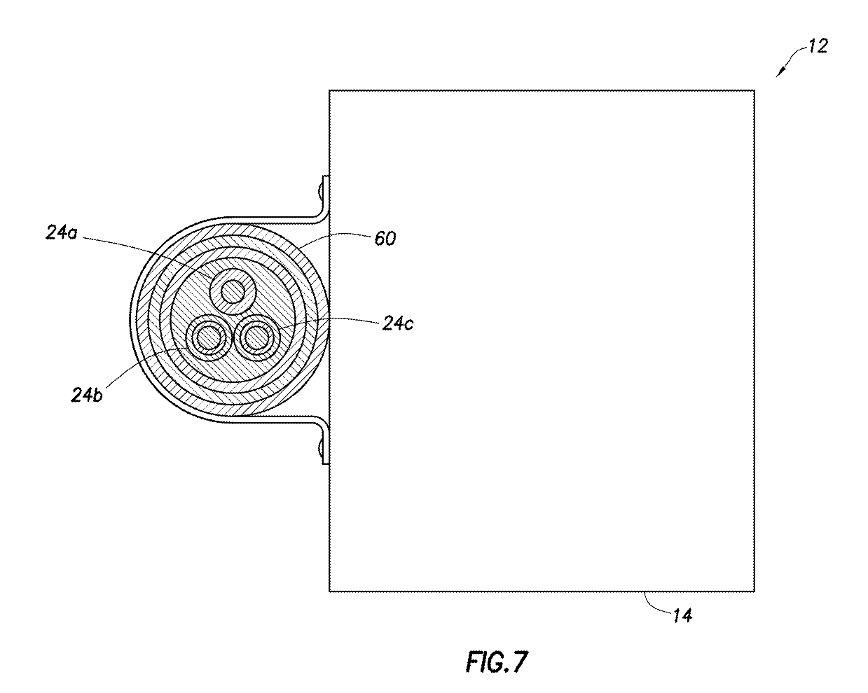

Referring additionally now to FIG. 7, another configuration of the sensing system 12 is representatively illustrated. In this configuration, the cable 60 is not necessarily used in a wellbore.

As depicted in FIG. 7, the cable 60 is securely attached to the object 14 (which has the transmitter 42 and battery 36 therein, with a sensor and a processor in some embodiments). The object 14 communicates with the cable 60 by transmitting signals to the electrical line 24a and/or optical waveguides 24b,c through the materials of the enclosures (the dielectric material 70, conductive braid 72, barrier layer 74 and outer armor braid 76) surrounding the electrical line and optical waveguides.

Thus, there is no direct electrical or optical connection between the transmitter 42 of the object 14 and the electrical line 24a or optical waveguides 24b,c of the cable 60. One benefit of this arrangement is that connections do not have to be made in the electrical line 24a or optical waveguides 24b,c, thereby eliminating this costly and time-consuming step. Another benefit is that potential failure locations are eliminated (connections are high percentage failure locations). Yet another benefit is that optical signal attenuation is not experienced at each of multiple connections to the objects 14.

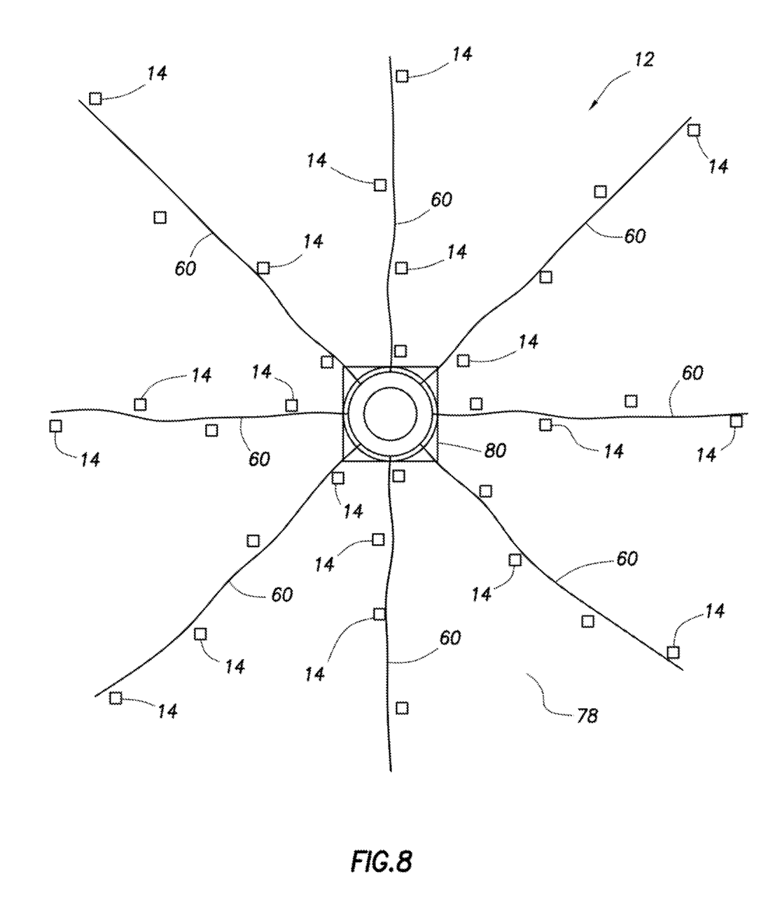

Referring additionally now to FIG. 8, another configuration of the sensing system 12 is representatively illustrated. In this configuration, multiple cables 60 are distributed on a sea floor 78, with multiple objects 14 distributed along each cable. Although a radial arrangement of the cables 60 and objects 14 relative to a central facility 80 is depicted in FIG. 8, any other arrangement or configuration of the cables and objects may be used in keeping with the principles of this disclosure.

The sensors in the objects 14 of FIGS. 7 & 8 could, for example, be tiltmeters used to precisely measure an angular orientation of the sea floor 78 over time. The lack of a direct signal connection between the cables 60 and the objects 14 can be used to advantage in this situation by allowing the cables and objects to be separately installed on the sea floor 78.

For example, the objects 14 could be installed where appropriate for monitoring the angular orientations of particular locations on the sea floor 78 and then, at a later time, the cables 60 could be distributed along the sea floor in close proximity to the objects (e.g., within a few meters). It would not be necessary to attach the cables 60 to the objects 14 (as depicted in FIG. 7), since the transmitter 42 of each object can transmit signals some distance to the nearest cable (although the cables could be secured to the objects, if desired).

As another alternative, the cables 60 could be installed first on the sea floor 78, and then the objects 14 could be installed in close proximity (or attached) to the cables. Another advantage of this system 12 is that the objects 14 can be individually retrieved, if necessary, for repair, maintenance, etc. (e.g., to replace the battery 36) as needed, without a need to disconnect electrical or optical connectors, and without a need to disturb any of the cables 60.

It may now be fully appreciated that the well system, sensing system and associated methods described above provide significant advancements to the art. In particular, the sensing system 12 can conveniently monitor displacement, position, location, characteristics, etc. of the object 14.

The above disclosure provides to the art a well system 10 which can include at least one object 14 having a transmitter 42, and at least one sensing device 24 which monitors displacement of the object 14 along a wellbore 16.

The transmitter 42 may comprise an acoustic transmitter, an electromagnetic transmitter and/or a thermal transmitter. A signal transmitted from the object 14 to the sensing device 24 may comprise an acoustic signal, and electromagnetic signal and/or a thermal signal.

The sensing device 24 may comprise an optical waveguide 24b,c. An interrogation system 32 may detect Brillouin backscatter gain or coherent Rayleigh backscatter resulting from light transmitted through the optical waveguide 24b,c.

The sensing device 24 may comprise an antenna.

The object 14 may comprise a ball which seals off a perforation 28.

The object 14 may fall through the wellbore 16 by operation of gravity, or the object 14 may be pushed through the wellbore 16 by fluid flow.

The object 14 may comprise a well tool 50, 52, 56, 58.

The sensing device 24 may sense a position of the object 14 along the wellbore 16.

An interrogation system 32 may detect triboelectric noise or piezoelectric energy generated in response to a signal transmitted by the transmitter 42.

The sensing device 24 may be positioned external to a casing 18, and the object 14 may displace through an interior of the casing 18.

Also described by the above disclosure is a method of monitoring at least one object 14 in a subterranean well. The method can include positioning at least one sensing device 24 in a wellbore 16 of the well, and then displacing the object 14 through the wellbore 16. The sensing device 24 monitors the object 14 as it displaces through the wellbore 16.

The sensing device 24 may comprise an optical waveguide 24b,c or an antenna.

The object 14 may comprise a ball, and the method can include sealing off a perforation 28 with the ball.

Displacing the object 14 can include the object 14 falling through the wellbore 16 by operation of gravity or pushing the object 14 through the wellbore 16 by fluid flow.

The object 14 may comprise a well tool 50, 52, 56, 58.

Monitoring the object 14 can include the sensing device 24 sensing a position of the object 14 along the wellbore 16.

Positioning the sensing device 24 can include securing the sensing device 24 external to a casing 18.

Monitoring the object 14 can include transmitting a signal to the sensing device 24 from a transmitter 42 of the object 14. The transmitter 42 may comprise an acoustic transmitter, an electromagnetic transmitter and/or a thermal transmitter.

Transmitting the signal can include generating triboelectric noise or piezoelectric energy in the sensing device 24.

It is to be understood that the various examples described above may be utilized in various orientations, such as inclined, inverted, horizontal, vertical, etc., and in various configurations, without departing from the principles of the present disclosure. The embodiments illustrated in the drawings are depicted and described merely as examples of useful applications of the principles of the disclosure, which are not limited to any specific details of these embodiments.

In the above description of the representative examples of the disclosure, directional terms, such as “above,” “below,” “upper,” “lower,” etc., are used for convenience in referring to the accompanying drawings. In general, “above,” “upper,” “upward” and similar terms refer to a direction toward the earth's surface along a wellbore, and “below,” “lower,” “downward” and similar terms refer to a direction away from the earth's surface along the wellbore.

Of course, a person skilled in the art would, upon a careful consideration of the above description of representative embodiments, readily appreciate that many modifications, additions, substitutions, deletions, and other changes may be made to these specific embodiments, and such changes are within the scope of the principles of the present disclosure. Accordingly, the foregoing detailed description is to be clearly understood as being given by way of illustration and example only, the spirit and scope of the present invention being limited solely by the appended claims and their equivalents.

What is claimed is:

1. A well system, comprising:
at least one object having a transmitter; and
at least one sensing device which monitors displacement of the object along a wellbore.

2. The well system of claim 1, wherein the transmitter comprises an acoustic transmitter.

3. The well system of claim 1, wherein the transmitter comprises an electromagnetic transmitter.

4. The well system of claim 1, wherein the sensing device comprises an optical waveguide.

5. The well system of claim 4, wherein an interrogation system detects Brillouin backscatter gain resulting from light transmitted through the optical waveguide.

6. The well system of claim 4, wherein an interrogation system detects coherent Rayleigh backscatter resulting from light transmitted through the optical waveguide.

7. The well system of claim 1, wherein the sensing device comprises an antenna.

8. The well system of claim 1, wherein the transmitter comprises a thermal transmitter.

9. The well system of claim 1, wherein the object comprises a ball which seals off a perforation.

10. The well system of claim 1, wherein the object falls through the wellbore by operation of gravity.

11. The well system of claim 1, wherein the object is pushed through the wellbore by fluid flow.

12. The well system of claim 1, wherein the object comprises a well tool.

13. The well system of claim 1, wherein the sensing device senses a position of the object along the wellbore.

14. The well system of claim 1, wherein the transmitter transmits to the sensing device a signal comprising at least one of an acoustic signal, an electromagnetic signal and a thermal signal.

15. The well system of claim 1, wherein an interrogation system detects triboelectric noise generated in response to a signal transmitted by the transmitter.

16. The well system of claim 1, wherein an interrogation system detects piezoelectric energy generated in response to a signal transmitted by the transmitter.

17. The well system of claim 1, wherein the sensing device is positioned external to a casing, and wherein the object displaces through an interior of the casing.

18. A method of monitoring at least one object in a subterranean well, the method comprising:
positioning at least one sensing device in a wellbore of the well; and
then displacing the object through the wellbore, the sensing device monitoring the object as it displaces through the wellbore.

19. The method of claim 18, wherein the sensing device comprises an optical waveguide.

20. The method of claim 19, wherein an interrogation system detects Brillouin backscatter gain resulting from light transmitted through the optical waveguide.

21. The method of claim 19, wherein an interrogation system detects coherent Rayleigh backscatter resulting from light transmitted through the optical waveguide.

22. The method of claim 18, wherein the sensing device comprises an antenna.

23. The method of claim 18, wherein the object comprises a ball, and wherein the method further comprises sealing off a perforation with the ball.

24. The method of claim 18, wherein displacing the object further comprises the object falling through the wellbore by operation of gravity.

25. The method of claim 18, wherein displacing the object further comprises pushing the object through the wellbore by fluid flow.

26. The method of claim 18, wherein the object comprises a well tool.

27. The method of claim 18, wherein monitoring the object further comprises the sensing device sensing a position of the object along the wellbore.

28. The method of claim 18, wherein positioning the sensing device further comprises securing the sensing device external to a casing.

29. The method of claim 18, wherein monitoring the object further comprises transmitting a signal to the sensing device from a transmitter of the object.

30. The method of claim 29, wherein the transmitter comprises an acoustic transmitter.

31. The method of claim 29, wherein the transmitter comprises an electromagnetic transmitter.

32. The method of claim 29, wherein the transmitter comprises a thermal transmitter.

33. The method of claim 29, wherein transmitting the signal further comprises transmitting an indication of a configuration of the object.

34. The method of claim 29, wherein transmitting the signal further comprises generating triboelectric noise in the sensing device.

35. The method of claim 29, wherein transmitting the signal further comprises generating piezoelectric energy in the sensing device.
